(19) United States
(12) Patent Application Publication
(10) Pub. No.: US 2023/0169337 A1
(43) Pub. Date: Jun. 1, 2023

(54) DEVICE AND METHOD FOR PARALLEL PROCESSING OF DEEP LEARNING MODEL

(71) Applicant: TUNiB Inc., Seoul (KR)

(72) Inventors: Hyun Woong Ko, Seongnam-si (KR); Kyubyong Park, Seongnam-si (KR)

(73) Assignee: TUNiB Inc., Seoul (KR)

(21) Appl. No.: 18/056,861

(22) Filed: Nov. 18, 2022

(30) Foreign Application Priority Data
Nov. 30, 2021 (KR) 10-2021-0168490

(51) Int. Cl. G06N 3/08; G06N 3/04; G06N 3/10

(52) U.S. Cl. CPC G06N 3/08; G06N 3/04; G06N 3/10

(57) ABSTRACT

A deep learning model parallel processing method that is performed by a deep learning model parallel processing device includes loading a deep learning model to a main process by a central processing unit (CPU), partitioning parallelizable parameters included in the deep learning model by the CPU and storing the partitioned parallelizable parameters in a shared memory, calculating partition parameters partitioned from the parallelizable parameters by a sub-process in each of a plurality of graphic processing units (GPUs) while access of the main process to the shared memory is stopped, obtaining a calculation result of the partition parameters from the shared memory by the CPU and outputting the calculation result by the CPU.

### CROSS-REFERENCE TO RELATED APPLICATION

This application claims the benefit under 35 U.S.C. § 119(a) of Korean Patent Applications No. 10-2021-0168490 filed on Nov. 30, 2021 in the Korean Intellectual Property Office, the entire disclosures of which are incorporated herein by reference for all purposes.

### TECHNICAL FIELD

The present disclosure relates to a device and method for parallel processing of deep learning model.

### BACKGROUND

In general, deep learning is carried out by repeatedly performing feedforward learning and backpropagation learning. The feedforward learning is a procedure of calculating features and objective functions from an input layer to an output layer through several hidden layers, and the backpropagation learning is a procedure of correcting weights from the output layer to the input layer through the hidden layers by reflecting the differences, i.e., errors, between the feedforward calculation results and the true answers.

FIG. 1 is a diagram illustrating a parallel processing of a deep learning model according to the prior art. As shown in FIG. 1, according to the prior art, a deep learning model 100 is partitioned into a first model 110 and a second model 120, and the partitioned first model 110 and second model 120 perform deep learning in a parallel distributed manner.

During training of the deep learning model 100, weights are repeatedly updated to minimize errors. Therefore, as shown in FIG. 1, if the deep learning model 100 is partitioned into the first model 110 and the second model 120, learning results of the first model 110 and the second model 120, i.e., weights and features (parameters) need to be shared.

However, the prior art is accompanied by inefficient processing of distributed data, parallel processing of the deep learning models, sharing of distributed parameters, a communication protocol and synchronization. To be specific, a sequence-to-sequence model such as BlenderBot is not available for parallelization, or the existing tools are very complicated to use, or the use of memories (GPU, CPU, etc.) is inefficient.

The present application was made with the support of the Ministry of Science and ICT, under Project No. R-20210726-011600, which was conducted under the research project entitled “Commercialization of Excellent Research from 2021 Artificial Intelligence Online Competition” within the project named “Open Competition Platform Construction Project.”

### PRIOR ART DOCUMENT

### Patent Document

(Patent Document 1) Korean Patent Laid-open Publication No. 10-2021-0112082 (published on Sep. 14, 2021)

(Patent Document 2) Korean Patent No. 10-2029711 (registered on Oct. 1, 2019)

### SUMMARY

In view of the foregoing, the present disclosure provides a device, method and computer program for parallel processing of a deep learning model that can be extended to various deep learning models and can improve inefficiency in memories that occurs during partition and parallelization of a deep learning model.

However, the problems to be solved by the present disclosure are not limited to the above-described problems. There may be other problems to be solved by the present disclosure.

As a means for solving the problems, according to an aspect of the present disclosure, a deep learning model parallel processing method that is performed by a deep learning model parallel processing device comprises loading a deep learning model to a main process by a central processing unit (CPU), partitioning parallelizable parameters included in the deep learning model by the CPU and storing the partitioned parallelizable parameters in a shared memory, calculating partition parameters partitioned from the parallelizable parameters by a sub-process in each of a plurality of graphic processing units (GPUs) while access of the main process to the shared memory is stopped, obtaining a calculation result of the partition parameters from the shared memory by the CPU and outputting the calculation result by the CPU.

According to another aspect of the present disclosure, deep learning model parallel processing device comprises a CPU that loads a deep learning model to a main process, partitions parallelizable parameters included in the deep learning model, and outputs a calculation result of partition parameters partitioned from the parallelizable parameters and a shared memory that is accessible by the main process and a plurality of sub-process and is able to store the partitioned parallelizable parameters for a predetermined period of time and store the calculation result for a predetermined period of time, wherein while access of the main process to the shared memory is stopped, the sub-process in each of a plurality of graphic processing units (GPUs) calculates the partition parameters.

The above-described aspects are provided by way of illustration only and should not be construed as liming the present disclosure. Besides the above-described embodiments, there may be additional embodiments described in the accompanying drawings and the detailed description.

According to the present disclosure, it can be extended to various deep learning models. For example, language models, vision models such as ViT and CLIP, and audio models such as Wav2Vec2 can be partitioned and parallelized.

Further, according to the present disclosure, parallel processing of a deep learning model is launched by a central processing unit (CPU) and partition parameters are calculated by a plurality of graphic processing units (GPUs). Therefore, it is possible to improve inefficiency in memories that has occurred in the prior art.

Furthermore, according to the present disclosure, it is possible to provide a device, method and computer program for parallel processing of a deep learning model that can improve inefficiency of repeated execution of a portion of a user code that needs to be executed only once by operating the user code in a main process and a framework code in a sub-process, and can enable a user to cancel parallelization without limitation.

### BRIEF DESCRIPTION OF THE DRAWINGS

In the detailed description that follows, embodiments are described as illustrations only since various changes and modifications will become apparent to a person with ordinary skill in the art from the following detailed description. The use of the same reference numbers in different figures indicates similar or identical items.

FIG. 1 is a diagram illustrating a parallel processing of a deep learning model according to the prior art.

FIG. 2 illustrates a configuration of a deep learning model parallel processing device according to an embodiment of the present disclosure.

FIG. 3 is a diagram for explaining a process of producing first output parameters and second output parameters according to an embodiment of the present disclosure.

FIG. 4 is a diagram for explaining a method of partitioning parameters corresponding to a first layer set by columns according to an embodiment of the present disclosure.

FIG. 5 is a diagram for explaining a process of producing third output parameters and fourth output parameters according to an embodiment of the present disclosure.

FIG. 6 is a diagram for explaining a method of partitioning parameters corresponding to a second layer set by rows according to an embodiment of the present disclosure.

FIG. 7 is a diagram for explaining a deep learning model according to an embodiment of the present disclosure.

FIG. 8 is a diagram for explaining a method of partitioning a self-attention layer according to an embodiment of the present disclosure.

FIG. 9 is a diagram for explaining a method of partitioning a multilayer perceptron layer according to an embodiment of the present disclosure.

FIG. 10 is a diagram for explaining an effect depending on a parameter partition method according to an embodiment of the present disclosure.

FIG. 11 illustrates a configuration of a deep learning model parallel processing system according to another embodiment of the present disclosure.

FIG. 12 is a flowchart showing a deep learning model parallel processing method according to an embodiment of the present disclosure.

### DETAILED DESCRIPTION

Hereafter, embodiments of the present disclosure will be described in detail with reference to the accompanying drawings so that the present disclosure may be readily implemented by a person with ordinary skill in the art. However, it is to be noted that the present disclosure is not limited to the embodiments but may be embodied in various other ways. In drawings, parts irrelevant to the description are omitted for the simplicity of explanation, and like reference numerals denote like parts through the whole document.

Throughout this document, the term “connected to” may be used to designate a connection or coupling of one element to another element and includes both an element being “directly connected” another element and an element being “electronically connected” to another element via another element. Further, it is to be understood that the terms “comprises,” “includes,” “comprising,” and/or “including” means that one or more other components, steps, operations, and/or elements are not excluded from the described and recited systems, devices, apparatuses, and methods unless context dictates otherwise; and is not intended to preclude the possibility that one or more other components, steps, operations, parts, or combinations thereof may exist or may be added.

Throughout this document, the term “unit” may refer to a unit implemented by hardware, software, and/or a combination thereof. As examples only, one unit may be implemented by two or more pieces of hardware or two or more units may be implemented by one piece of hardware. However, the “unit” is not limited to the software or the hardware and may be stored in an addressable storage medium or may be configured to implement one or more process.

Throughout this document, a part of an operation or function described as being carried out by a terminal or device may be implemented or executed by a server connected to the terminal or device. Likewise, a part of an operation or function described as being implemented or executed by a server may be so implemented or executed by a terminal or device connected to the server.

Hereinafter, embodiments of the present disclosure will be explained in detail with reference to the accompanying drawings.

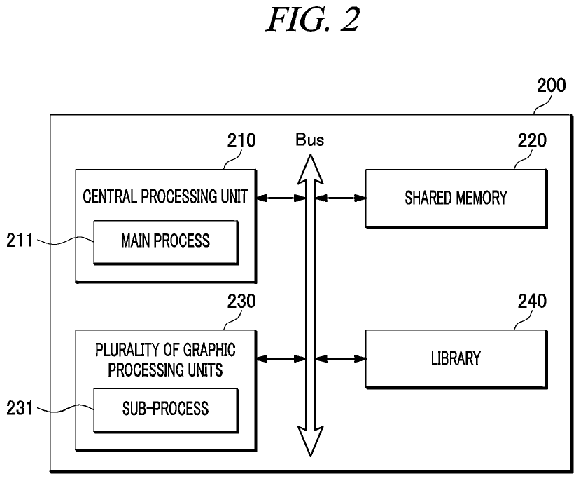

FIG. 2 illustrates a configuration of a deep learning model parallel processing device according to an embodiment of the present disclosure. Referring to FIG. 2, a deep learning model parallel processing device 200 may include a CPU 210, a shared memory 220, a plurality of GPUs 230 and a library 240. The CPU 210 may include a main process 211, and each of the plurality of GPUs 230 may include a sub-process 231. However, the above-described components 210 to 240 are just examples of components that can be controlled by the deep learning model parallel processing device 200.

The deep learning model parallel processing device 200 may partition a deep learning model and perform training on the deep learning model. For example, the deep learning model parallel processing device 200 may perform parallelization on various deep learning models including language models, vision models such as ViT and CLIP, and audio models such as Wav2Vec2.

The deep learning model parallel processing device 200 may launch parallel processing of the deep learning model in the CPU. That is, the CPU may partition the deep learning model and the plurality of GPUs may calculate partition parameters, and, thus, it is possible to improve inefficiency in memories that has occurred in the prior art.

The deep learning model parallel processing device 200 may operate a user code in the main process and a framework code in the sub-process. Therefore, the deep learning model parallel processing device 200 can improve inefficiency of repeated execution of a portion of the user code that needs to be executed only once. Further, the deep learning model parallel processing device 200 can enable a user to cancel parallelization without limitation.

The CPU 210 may load the deep learning model to the main process 211. Herein, the deep learning model may include a first layer set and a second layer set that is subsequent to the first layer set.

The CPU 210 may partition parallelizable parameters included in the deep learning model. For example, the CPU 210 may branch a framework code into the sub-process 231 in a user code that calls a parallel function. In this case, access of the main process 211 to the shared memory 220 may be stopped by a specific object (for example, mutex).

Then, the CPU 210 may parallelize the parallelizable parameters in the deep learning model. For example, the CPU 210 may partition the parameters by tensors within layers of the deep learning model. The CPU 210 may store the partition parameters in the shared memory 220, and the partition parameters may be distributed to any one of the plurality of GPUs 230 through the shared memory 220.

The CPU 210 may upload all of non-parallelizable parameters of the deep learning model to the plurality of GPUs 230.

The CPU 210 may partition parameters corresponding to a first layer set by columns into first partition parameters and second partition parameters. The CPU 210 may store the first partition parameters and the second partition parameters in the shared memory 220.

The CPU 210 may partition parameters corresponding to a second layer set by rows into third partition parameters and fourth partition parameters. The CPU 210 may store the third partition parameters and the fourth partition parameters in the shared memory 220.

As described above, the deep learning model parallel processing device 200 can partition the deep learning model in the CPU 210 and thus can solve inefficiency in memories that has occurred in the prior art. To be specific, according to the prior art, while all the parameters of the deep learning model are shared by the plurality of GPUs 230, parallelization of the deep learning model is launched. Thus, the memory usage of the plurality of GPUs 230 may exceed the limit.

Accordingly, the deep learning model parallel processing device 200 according to the present disclosure partitions the deep learning model in the CPU 210 and allows the partition parameters to be shared by the plurality of GPUs 230 and thus can solve the problem of the prior art.

The CPU 210 may output a calculation result of the partition parameters partitioned from the parallelizable parameters. For example, the CPU 210 may output a calculation result, which was stored in the shared memory 220 and calculated by the plurality of GPUs 230, through the main process 211.

The shared memory 220 can be accessed by the main process 211 and a plurality of sub-process 231 and can store the partitioned parallelizable parameters for a predetermined period of time. Further, the shared memory 220 may store a calculation result for a predetermined period of time.

For example, the shared memory 220 may store the partition parameters partitioned by the CPU 210 and the partition parameter calculation result calculated by the plurality of GPUs 230. That is, the plurality of GPUs 230 may share the partition parameters through the shared memory 220, and the CPU 210 may share the calculation result through the shared memory 220.

For example, the CPU 210 and the plurality of GPUs 230 may be implemented as a generator and a consumer through the shared memory 220. To be specific, before calculation of the deep learning model, partition parameters generated by the CPU 210 may be consumed by the plurality of GPUs 230 through the shared memory 220. Also, after calculation of the deep learning model, a calculation result made by the plurality of GPUs 230 may be consumed by the CPU 210 through the shared memory 220.

While access of the main process 211 to the shared memory 220 is stopped, the sub-process 231 in each of the plurality of GPUs 230 may calculate partition parameters. For example, the plurality of GPUs 230 may calculate partition parameters partitioned by the CPU 210.

A first sub-process in a first GPU among the plurality of GPUs 230 may perform calculation on the first partition parameters and produce first output parameters. The first GPU may store the produced first output parameters in the shared memory 220.

A second sub-process in a second GPU among the plurality of GPUs 230 may perform calculation on the second partition parameters and produce second output parameters. The second GPU may store the produced second output parameters in the shared memory 220.

The first sub-process in the first GPU among the plurality of GPUs 230 may perform calculation on the first output parameters and the third partition parameters and produce third output parameters.

The second sub-process in the second GPU among the plurality of GPUs 230 may perform calculation on the second output parameters and the fourth partition parameters and produce fourth output parameters.

A final calculation result may be produced by allowing the third output parameters and the fourth output parameters to be shared between the first GPU and the second GPU through the shared memory 220. For example, the plurality of GPUs 230 may store the final calculation result in the shared memory 220.

The CPU 210 may output a calculation result based on the final calculation result. For example, the CPU 210 may output the final calculation result stored in the shared memory 220.

The deep learning model parallel processing device 200 may further include the library 240 including a plurality of programs and a plurality of routines for the deep learning model. According to an embodiment of the present disclosure, a user code is operated in the main process 211, and a framework code for the plurality of programs and the plurality of routines may be operated in the sub-process 231. Accordingly, the deep learning model parallel processing device 200 according to the present disclosure can solve the problem of the prior art.

To be specific, according to the prior art, a framework code is operated in a main process and a user code is operated in a sub-process, and, thus, the framework code simultaneously execute the user code several times.

Therefore, according to the prior art, even a portion of the user code that needs to be executed only once is executed several times. Thus, a deep learning model is repeatedly loaded, which causes the memory usage of the CPU to exceed the limit. Also, the server is open to the same port several times. Also, according to the prior art, parallelization is launched in the framework code, and, thus, parallelization cannot be canceled in the user code. That is, parallelization can be performed and can be canceled in the main process, but parallelization cannot be canceled in the sub-process.

Unlike the prior art, the deep learning model parallel processing device 200 according to the present disclosure is configured such that the user code is operated in the main process 211 and the framework code is operated in the sub-process 231, and, thus, the user code can simultaneously call the framework code several times.

Accordingly, the deep learning model parallel processing device 200 may allow only a portion of the user code that needs to be executed several times to be executed several times, and parallelization may be launched by the user code, i.e., the main process 211. Therefore, a user can cancel parallelization without limitation in the main process 211 or the sub-process 231.

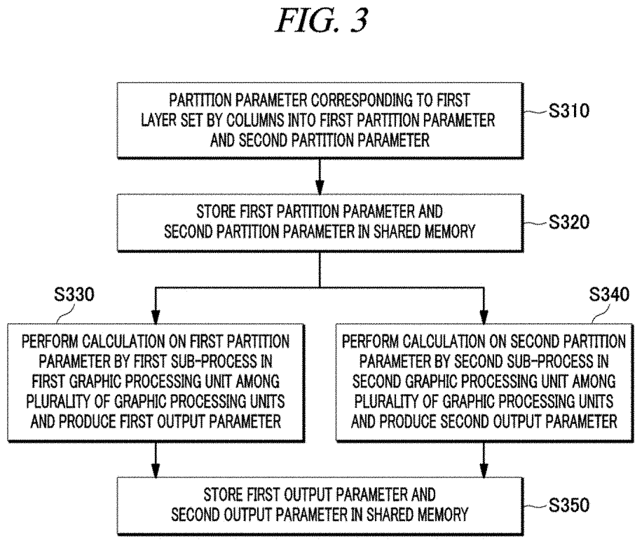

FIG. 3 is a diagram for explaining a process of producing first output parameters and second output parameters according to an embodiment of the present disclosure. Referring to FIG. 3, the CPU of the deep learning model parallel processing device 200 may partition partitionable parameters of the first layer set by columns and generate a plurality of partition parameters, and the plurality of GPUs may perform calculation on the partition parameters, respectively, through the shared memory.

The deep learning model parallel processing device 200 may partition parameters corresponding to a first layer set by columns into first partition parameters and second partition parameters (S310). For example, the deep learning model parallel processing device 200 may partition the parameters corresponding to the first layer set in a vertical direction.

The deep learning model parallel processing device 200 may store the first partition parameters and the second partition parameters in a shared memory (S320).

The deep learning model parallel processing device 200 may perform calculation on the first partition parameters by a first sub-process in a first GPU among a plurality of GPUs and produce first output parameters (S330).

The deep learning model parallel processing device 200 may perform calculation on the second partition parameters by a second sub-process in a second GPU among the plurality of GPUs and produce second output parameters (S340).

The deep learning model parallel processing device 200 may store the first output parameters and the second output parameters in the shared memory (S350).

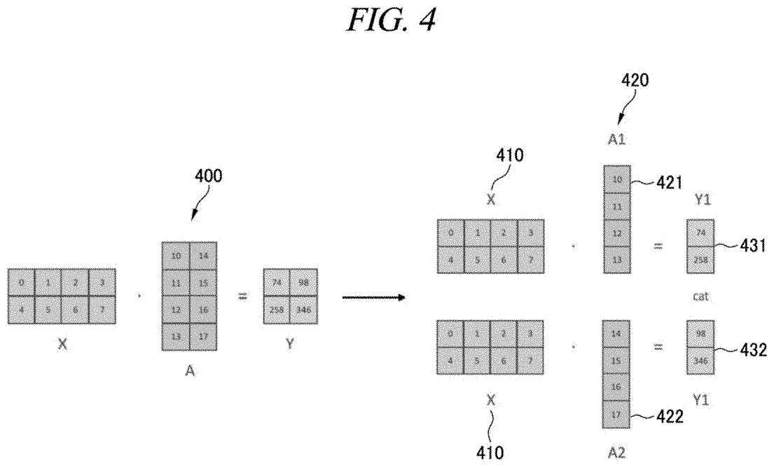

FIG. 4 is a diagram for explaining a method of partitioning parameters corresponding to a first layer set by columns according to an embodiment of the present disclosure. Referring to FIG. 4, the deep learning model parallel processing device 200 may partition parallelizable parameters 420 included in at least a part 400 of a deep learning model by columns in a CPU.

Herein, the deep learning model may include a first layer set that can be parallelized and a second layer set that is subsequent to the first layer set. For example, the deep learning model parallel processing device 200 may partition parameters corresponding to the first layer set by columns by columns and parameters corresponding to the second layer set subsequent to the first layer set by rows.

First, referring to FIG. 4, a process of partitioning the parallelizable parameters 420 corresponding to the first layer set by columns and performing calculation using partitioned parameters 421 and 422 will be described. For example, the deep learning model parallel processing device 200 may partition the parallelizable parameters 420 of the first layer set by columns in the CPU. The deep learning model parallel processing device 200 may partition the first layer set into first partition parameters 421 and second partition parameters 422. The deep learning model parallel processing device 200 may store the first partition parameters 421 and second partition parameters 422 in a shared memory.

For example, the deep learning model parallel processing device 200 may calculate the partition parameters 421 and 422 in a plurality of GPUs, respectively. In this case, the deep learning model parallel processing device 200 may copy input parameters 410 into both a first GPU and a second GPU.

The deep learning model parallel processing device 200 may perform a dot production operation on the input parameters 410 and the first partition parameters 421 by a first sub-process in the first GPU and produce first output parameters 431. The deep learning model parallel processing device 200 may perform a dot production operation on the input parameters 410 and the second partition parameters 422 by a second sub-process in the second GPU and produce second output parameters 432.

For example, the deep learning model parallel processing device 200 may store the first output parameters 431 and the second output parameters 432 produced by the plurality of GPUs, respectively, in the shared memory.

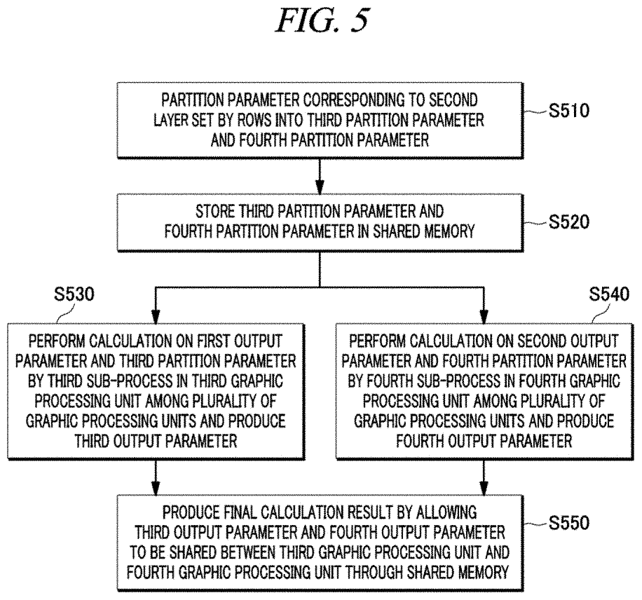

FIG. 5 is a diagram for explaining a process of producing third output parameters and fourth output parameters according to an embodiment of the present disclosure. Referring to FIG. 5, the deep learning model parallel processing device 200 may partition parallelizable parameters of a second layer set by rows in the CPU into a plurality of partition parameters, and may allow the partition parameters to be calculated by the plurality of GPUs through the shared memory.

The deep learning model parallel processing device 200 may partition parameters corresponding to the second layer set by rows into third partition parameters and fourth partition parameters (S510). For example, the deep learning model parallel processing device 200 may partition the parameters corresponding to the second layer set in a horizontal direction.

The deep learning model parallel processing device 200 may store the third partition parameters and the fourth partition parameters in the shared memory (S520).

The deep learning model parallel processing device 200 may perform calculation on the first output parameters and the third partition parameters by the first sub-process in the first GPU among the plurality of GPUs and produce third output parameters (S530).

The deep learning model parallel processing device 200 may perform calculation on the second output parameters and the fourth partition parameters by the second sub-process in the second GPU among the plurality of GPUs and produce fourth output parameters (S540).

The deep learning model parallel processing device 200 may produce a final calculation result by allowing the third output parameters and the fourth output parameters to be shared between the first GPU and the second GPU through the shared memory (S550).

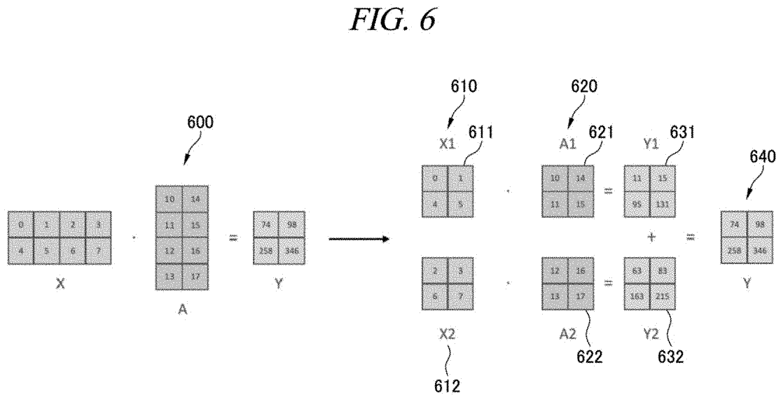

FIG. 6 is a diagram for explaining a method of partitioning parameters corresponding to a second layer set by rows according to an embodiment of the present disclosure. Referring to FIG. 6, the deep learning model parallel processing device 200 may partition parallelizable parameters 620 included in a deep learning model 600 by rows in the CPU.

For example, the deep learning model parallel processing device 200 may partition the parallelizable parameters 620 of the second layer set by rows. The deep learning model parallel processing device 200 may partition the second layer set into third partition parameters 621 and fourth partition parameters 622. The deep learning model parallel processing device 200 may store the third partition parameters 621 and the fourth partition parameters 622 in the shared memory.

For example, the deep learning model parallel processing device 200 may calculate the partition parameters 621 and 622 in the plurality of GPUs, respectively.

In this case, the deep learning model parallel processing device 200 may partition input parameters 610 by rows into first input parameters 611 and second input parameters 612. The deep learning model parallel processing device 200 may perform a dot production operation on the first input parameters 611 and the third partition parameters 621 by the first sub-process in the first GPU and produce third output parameters 631. The deep learning model parallel processing device 200 may perform a dot production operation on the second input parameters 612 and the fourth partition parameters 622 by the second sub-process in the second GPU and produce fourth output parameters 632.

For example, the deep learning model parallel processing device 200 may store the third output parameters 631 and the fourth output parameters 632 produced by the plurality of GPUs, respectively, in the shared memory.

In this case, the first GPU and the second GPU may share the third output parameters 631 and the fourth output parameters 632 through the shared memory. The deep learning model parallel processing device 200 may produce a final calculation result 640 by combining the third output parameters 631 and the fourth output parameters 632.

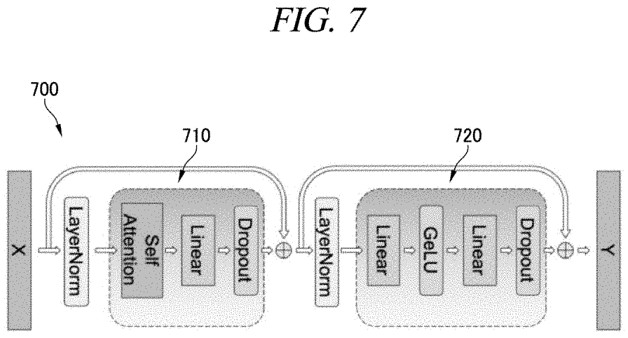

FIG. 7 is a diagram for explaining a deep learning model according to an embodiment of the present disclosure. Referring to FIG. 7, the deep learning model parallel processing device 200 may load a deep learning model 700 to a main process in the CPU.

The deep learning model 700 illustrated in FIG. 7 may include a self-attention layer 710 and a multilayer perceptron (MLP) layer 720. Herein, parallelizable parameters may correspond to the self-attention layer 710 and the MLP layer 720.

The self-attention layer 710 illustrated in FIG. 7 relates to a language learning model, and may learn each word included in text information. To be specific, the self-attention layer 710 may perform learning to derive a specific word relevant to each word included in the text information which is an input value.

Also, the MLP layer 720 is one of feedforward artificial neural network models and composed of three or more node layers including an input layer, a hidden layer and an output layer.

For example, the deep learning model parallel processing device 200 may partition parallelizable parameters included in the deep learning model 700. The deep learning model parallel processing device 200 may partition and parallelize each of the self-attention layer 710 and the MLP layer 720 in the CPU.

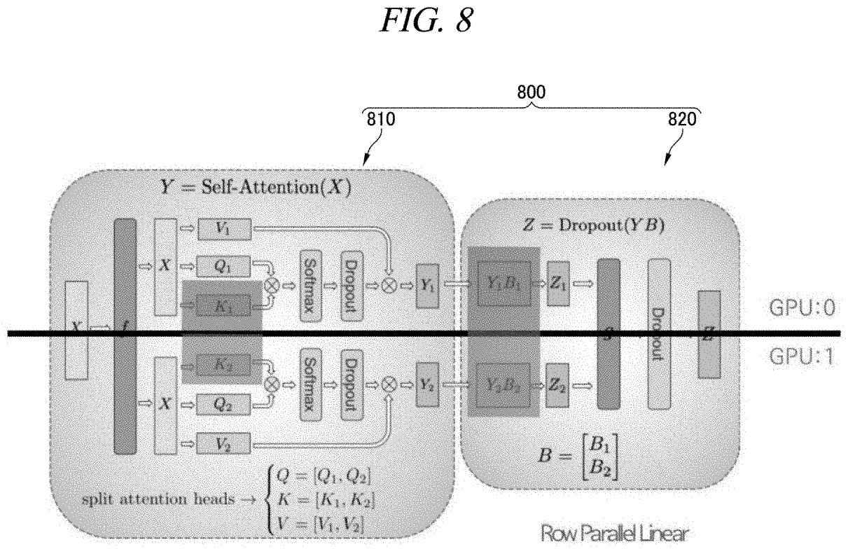

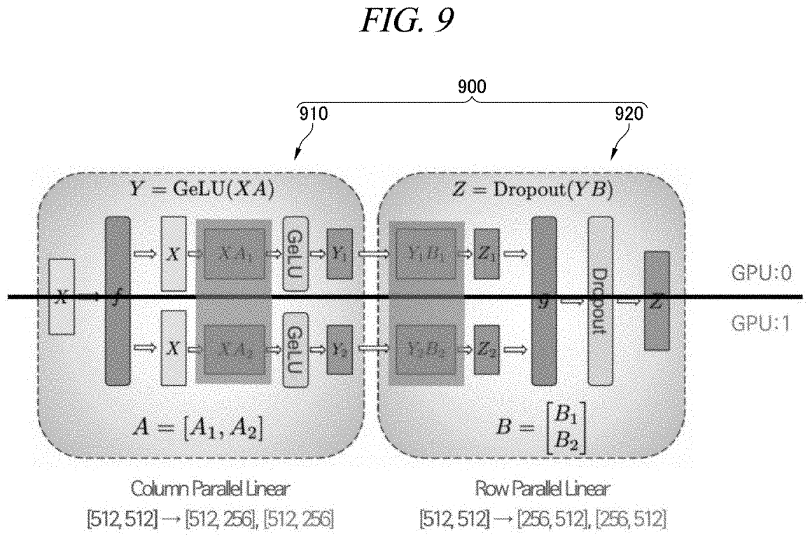

Hereafter, a process of partitioning parallelizable parameters by the deep learning model 700 illustrated in FIG. 7 will be described with reference to FIG. 8 and FIG. 9.

FIG. 8 is a diagram for explaining a method of partitioning a self-attention layer according to an embodiment of the present disclosure. Referring to FIG. 8, the deep learning model parallel processing device 200 may partition parameters 810 corresponding to a first linear projection part of a self-attention layer 800 by columns in the CPU.

For example, the deep learning model parallel processing device 200 may partition columns of a matrix of the parameters 810 corresponding to the first linear projection part in the CPU and upload first partition parameters and second partition parameters to the first GPU and the second GPU, respectively.

For example, the deep learning model parallel processing device 200 may partition parameters 820 corresponding to a first output projection part subsequent to the first linear projection part by rows in the CPU.

For example, the deep learning model parallel processing device 200 may partition rows of a matrix of the parameters 820 corresponding to the first output projection part in the CPU and upload third partition parameters and fourth partition parameters to the first GPU and the second GPU, respectively.

For example, the deep learning model parallel processing device 200 may copy and upload the same input parameters to the first GPU and the second GPU.

For example, the deep learning model parallel processing device 200 may perform calculation on the parameters 810 corresponding to the first linear projection part in a parallel manner by the first GPU and the second GPU, and may perform calculation on the parameters 820 corresponding to the first output projection part by the first GPU and a fourth GPU.

For example, the deep learning model parallel processing device 200 may derive a final calculation result by combining all of calculation results produced by the first GPU, the second GPU, the third GPU and the fourth GPU, respectively.

FIG. 9 is a diagram for explaining a method of partitioning a multilayer perceptron layer according to an embodiment of the present disclosure. Referring to FIG. 9, the deep learning model parallel processing device 200 may partition parameters 910 corresponding to a second linear projection part of a MPL 900 by columns in the CPU.

For example, the deep learning model parallel processing device 200 may partition columns of a matrix of the parameters 910 corresponding to the second linear projection part in the CPU and upload first partition parameters and second partition parameters to the first GPU and the second GPU, respectively.

For example, the deep learning model parallel processing device 200 may partition parameters 920 corresponding to a second output projection part subsequent to the second linear projection part by rows in the CPU.

For example, the deep learning model parallel processing device 200 may partition rows of a matrix of the parameters 920 corresponding to the second output projection part in the CPU and upload third partition parameters and fourth partition parameters to the first GPU and the second GPU, respectively.

For example, the deep learning model parallel processing device 200 may copy and upload the same input parameters to the first GPU and the second GPU.

For example, the deep learning model parallel processing device 200 may perform calculation on the parameters 910 corresponding to the second linear projection part in a parallel manner by the first GPU and the second GPU, and may perform calculation on the parameters 920 corresponding to the second output projection part by the first GPU and the fourth GPU.

For example, the deep learning model parallel processing device 200 may derive a final calculation result by combining all of calculation results produced by the first GPU, the second GPU, the third GPU and the fourth GPU, respectively.

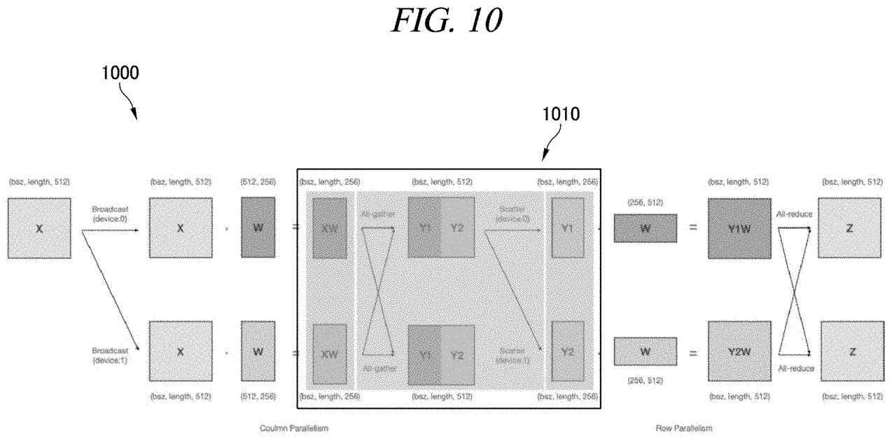

FIG. 10 is a diagram for explaining an effect depending on a parameter partition method according to an embodiment of the present disclosure. As described above with reference to FIG. 7 to FIG. 9, the deep learning model parallel processing device 200 according to the present disclosure may partition first parallelizable parameters of a deep learning model 1000 by columns and second parameters subsequent to the first parameters by rows. That is, the deep learning model parallel processing device 200 may partition the parallelizable parameters sequentially from partition by columns to partition by rows.

Therefore, when the deep learning model parallel processing device 200 according to the present disclosure perform a partition operation on the deep learning model in the CPU, the preceding first parameters among the parallelizable parameters may be partitioned by columns and the second parameters subsequent to the first parameters may be partitioned by rows. Thus, operations 1010 including All-gather and Scatter can be omitted.

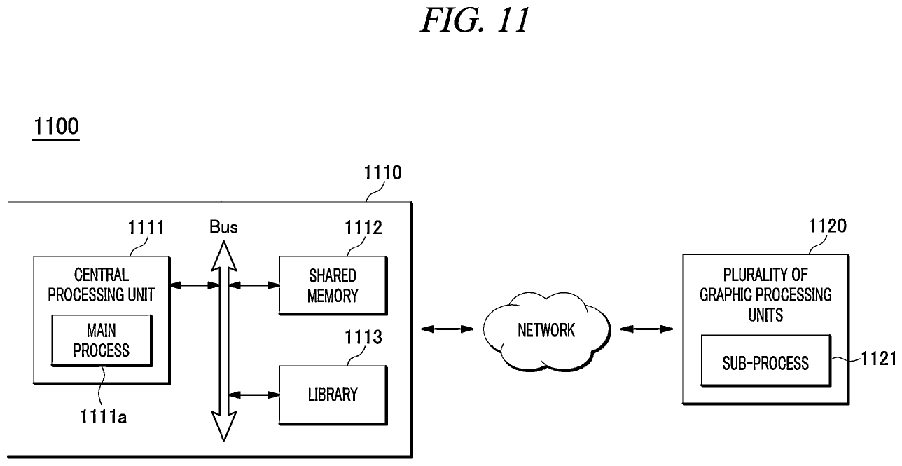

FIG. 11 illustrates a configuration of a deep learning model parallel processing system according to another embodiment of the present disclosure. Referring to FIG. 11, a deep learning model parallel processing system 1100 may include a deep learning model parallel processing device 1110 and a plurality of GPUs 1120. The deep learning model parallel processing device 1110 may include a CPU 1111, a shared memory 1112 and a library 1113, and each of the plurality of GPUs 1120 may include a sub-process 1121. The CPU 1111 may include a main process 1111a. However, the above-described components 1110 to 1120 are just examples of components that can be controlled by the deep learning model parallel processing system 1100.

According to another embodiment, the plurality of GPUs 1120 may be a device physically separated from the deep learning model parallel processing device 1110, and may be, for example, a server. As shown in FIG. 11, the deep learning model parallel processing system 1100 may partition a deep learning model in the deep learning model parallel processing device 1110 and calculate partitioned partition parameters in the plurality of GPUs 1120.

To be specific, the deep learning model parallel processing system 1100 may partition the deep learning model in the CPU 1111 of the deep learning model parallel processing device 1110 into partition parameters and store the partition parameters in the shared memory 1112.

The deep learning model parallel processing system 1100 may share the partition parameters with the plurality of GPUs 1120 through the shared memory 1112, and the plurality of GPUs 1120 may perform calculation on each of the partition parameters in a plurality of sub-process 1121.

The plurality of GPUs 1120 may store a calculation result of each of the partition parameters in the shared memory 1112, produce a final calculation result by allowing the calculation result to be shared with each other through the shared memory 1112, and store the produced final calculation result in the shared memory 1112.

The deep learning model parallel processing system 1100 may output the calculation result based on the final calculation result in the CPU 1111. For example, the CPU 1111 may output the final calculation result stored in the shared memory 1112.

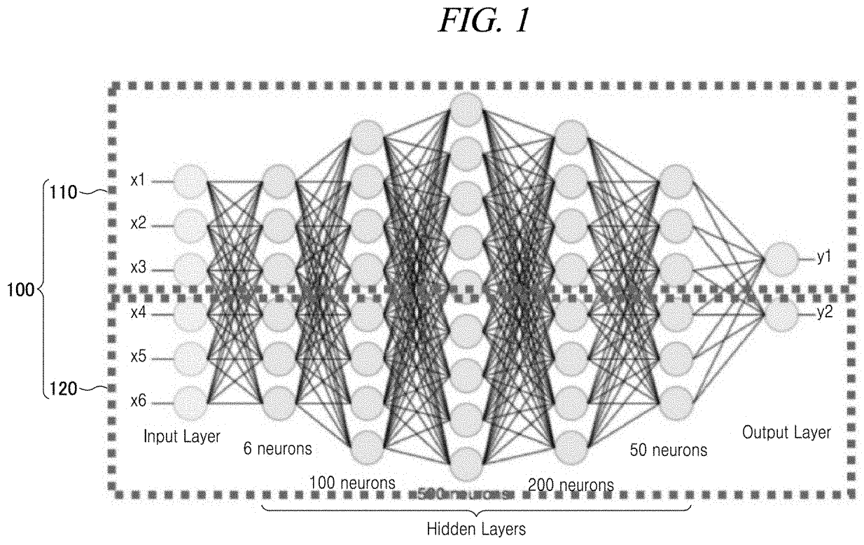

Detailed operations of the deep learning model parallel processing device 1110 and the plurality of GPUs 1120 are the same as described above with reference to FIG. 1 to FIG. 10. Therefore, a description thereof will be omitted.

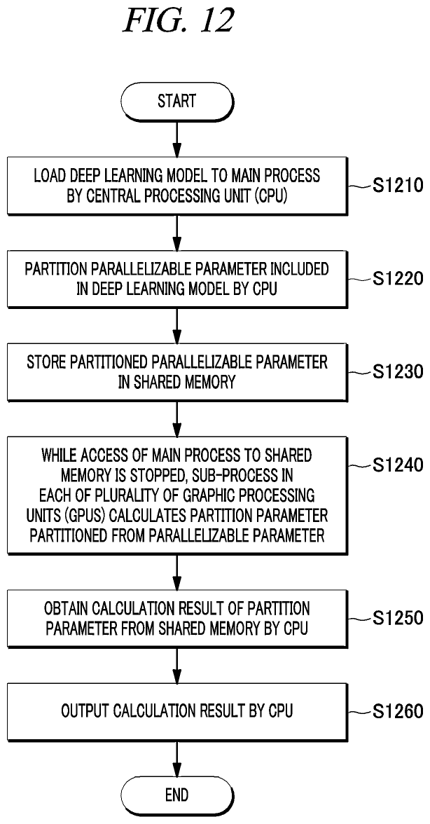

FIG. 12 is a flowchart showing a deep learning model parallel processing method according to an embodiment of the present disclosure. The deep learning model parallel processing method illustrated in FIG. 12 includes the processes time-sequentially performed according to the embodiments illustrated in FIG. 2 to FIG. 11. Therefore, the above descriptions of the processes may also be applied to the deep learning model parallel processing method by the deep learning model parallel processing device according to the embodiments illustrated in FIG. 2 to FIG. 11, even though they are omitted hereinafter.

In a process S1210, a deep learning model parallel processing device may load a deep learning model to a main process by a CPU.

In a process S1220, the deep learning model parallel processing device may partition parallelizable parameters included in the deep learning model by the CPU.

In a process S1230, the deep learning model parallel processing device may store the partitioned parallelizable parameters in a shared memory.

In a process S1240, while access of the main process to the shared memory is stopped, a sub-process in each of a plurality of GPUs of the deep learning model parallel processing device may calculate partition parameters partitioned from the parallelizable parameters.

In a process S1250, the deep learning model parallel processing device may obtain a calculation result of the partition parameters from the shared memory by the CPU.

In a process S1260, the deep learning model parallel processing device may output the calculation result by the CPU.

In the descriptions above, the processes S1210 to S1260 may be divided into additional processes or combined into fewer processes depending on an embodiment. In addition, some of the processes may be omitted and the sequence of the processes may be changed if necessary.

The deep learning model parallel processing method by the deep learning model parallel processing apparatus described above with reference to FIG. 1 to FIG. 12 can be implemented in a computer program stored in a medium to be executed by a computer or a storage medium including instructions codes executable by a computer. Also, the deep learning model parallel processing method by the deep learning model parallel processing apparatus described above with reference to FIG. 1 to FIG. 12 can be implemented in a computer program stored in a medium to be executed by a computer.

A computer-readable medium can be any usable medium which can be accessed by the computer and includes all volatile/non-volatile and removable/non-removable media. Further, the computer-readable medium may include computer storage medium. The computer storage medium includes all volatile/non-volatile and removable/non-removable media embodied by a certain method or technology for storing information such as computer-readable instruction code, a data structure, a program module or other data.

The above description of the present disclosure is provided for the purpose of illustration, and it would be understood by those skilled in the art that various changes and modifications may be made without changing technical conception and essential features of the present disclosure. Thus, it is clear that the above-described embodiments are illustrative in all aspects and do not limit the present disclosure. For example, each component described to be of a single type can be implemented in a distributed manner. Likewise, components described to be distributed can be implemented in a combined manner.

The scope of the present disclosure is defined by the following claims rather than by the detailed description of the embodiment. It shall be understood that all modifications and embodiments conceived from the meaning and scope of the claims and their equivalents are included in the scope of the present disclosure.

### EXPLANATION OF REFERENCE NUMERALS

200: Deep learning model parallel processing device
210: Central processing unit
211: Main process
220: Shared memory
230: Plurality of graphic processing units
231: Sub-process

We claim:

1. A deep learning model parallel processing method that is performed by a deep learning model parallel processing device, comprising:
loading a deep learning model to a main process by a central processing unit (CPU);
partitioning parallelizable parameters included in the deep learning model by the CPU and storing the partitioned parallelizable parameters in a shared memory;
calculating partition parameters partitioned from the parallelizable parameters by a sub-process in each of a plurality of graphic processing units (GPUs) while access of the main process to the shared memory is stopped;
obtaining a calculation result of the partition parameters from the shared memory by the CPU; and
outputting the calculation result by the CPU.

2. The deep learning model parallel processing method of claim 1,
wherein the deep learning model includes a first layer set and a second layer set that is subsequent to the first layer set, and
the calculating partition parameters includes:
partitioning parameters corresponding to the first layer set by columns into first partition parameters and second partition parameters; and
storing the first partition parameters and the second partition parameters in the shared memory.

3. The deep learning model parallel processing method of claim 2, further comprising:
performing calculation on the first partition parameters by a first sub-process in a first GPU among the plurality of GPUs and producing first output parameters;
performing calculation on the second partition parameters by a second sub-process in a second GPU among the plurality of GPUs and producing second output parameters; and
storing the first output parameters and the second output parameters in the shared memory.

4. The deep learning model parallel processing method of claim 3, further comprising:
partitioning parameters corresponding to the second layer set by rows into third partition parameters and fourth partition parameters; and
storing the third partition parameters and the fourth partition parameters in the shared memory.

5. The deep learning model parallel processing method of claim 4, further comprising:
performing calculation on the first output parameters and the third partition parameters by the first sub-process in the first GPU among the plurality of GPUs and producing third output parameters;
performing calculation on the second output parameters and the fourth partition parameters by the second sub-process in the second GPU among the plurality of GPUs and producing fourth output parameters; and
producing a final calculation result by allowing the third output parameters and the fourth output parameters to be shared between the first GPU and the second GPU through the shared memory.

6. The deep learning model parallel processing method of claim 5,
wherein the outputting a calculation result includes:
outputting the calculation result based on the final calculation result in the CPU.

7. The deep learning model parallel processing method of claim 1,
wherein the deep learning model includes a self-attention layer and a multilayer perceptron (MLP) layer, and
the parallelizable parameters correspond to the self-attention layer and the MLP layer.

8. The deep learning model parallel processing method of claim 7,
wherein the storing in the shared memory includes:
partitioning parameters corresponding to a first linear projection part of the self-attention layer by columns and partitioning parameters corresponding to a first output projection part subsequent to the first linear projection part by rows.

9. The deep learning model parallel processing method of claim 7,
wherein the storing in the shared memory includes:
partitioning parameters corresponding to a second linear projection part of the MLP layer by columns and partitioning parameters corresponding to a second output projection part subsequent to the second linear projection part by rows.

10. The deep learning model parallel processing method of claim 1, further comprising:
constructing a library including a plurality of programs and a plurality of routines for the deep learning model,
wherein a user code is operated in the main process, and a framework code for the plurality of programs and the plurality of routines is operated in the sub-process.

11. A deep learning model parallel processing device, comprising:
a CPU that loads a deep learning model to a main process, partitions parallelizable parameters included in the deep learning model, and outputs a calculation result of partition parameters partitioned from the parallelizable parameters; and
a shared memory that is accessible by the main process and a plurality of sub-process and is able to store the partitioned parallelizable parameters for a predetermined period of time and store the calculation result for a predetermined period of time,
wherein while access of the main process to the shared memory is stopped, the partition parameters are calculated by the sub-process in each of a plurality of graphic processing units (GPUs).

12. The deep learning model parallel processing device of claim 11,
wherein the deep learning model includes a first layer set and a second layer set that is subsequent to the first layer set, and
the CPU partitions parameters corresponding to the first layer set by columns into first partition parameters and second partition parameters, and stores the first partition parameters and the second partition parameters in the shared memory.

13. The deep learning model parallel processing device of claim 12,
wherein a first sub-process in a first GPU among the plurality of GPUs performs calculation on the first partition parameters, and produces first output parameters,
a second sub-process in a second GPU among the plurality of GPUs performs calculation on the second partition parameters, and produces second output parameters, and
the first output parameters and the second output parameters are stored in the shared memory.

14. The deep learning model parallel processing device of claim 13,
wherein the CPU partitions parameters corresponding to the second layer set by rows into third partition parameters and fourth partition parameters, and stores the third partition parameters and the fourth partition parameters in the shared memory.

15. The deep learning model parallel processing device of claim 14,
wherein the first sub-process in the first GPU among the plurality of GPUs performs calculation on the first output parameters and the third partition parameters, and produces third output parameters,
the second sub-process in the second GPU among the plurality of GPUs performs calculation on the second output parameters and the fourth partition parameters, and produces fourth output parameters, and
the first GPU and the second GPU share the third output parameters and the fourth output parameters through the shared memory, and produce a final calculation result.

16. The deep learning model parallel processing device of claim 15,
wherein the CPU outputs the calculation result based on the final calculation result.

17. The deep learning model parallel processing device of claim 11,
wherein the deep learning model includes a self-attention layer and a multilayer perceptron (MLP) layer, and
the parallelizable parameters correspond to the self-attention layer and the MLP layer.

18. The deep learning model parallel processing device of claim 17,
wherein the CPU partitions parameters corresponding to a first linear projection part of the self-attention layer by columns and partitions parameters corresponding to a first output projection part subsequent to the first linear projection part by rows.

19. The deep learning model parallel processing device of claim 17,
wherein the CPU partitions parameters corresponding to a second linear projection part of the MLP layer by columns and partitions parameters corresponding to a second output projection part subsequent to the second linear projection part by rows.

20. The deep learning model parallel processing device of claim 11, further comprising:
a library including a plurality of programs and a plurality of routines for the deep learning model,
wherein a user code is operated in the main process, and a framework code for the plurality of programs and the plurality of routines is operated in the sub-process.

21. A non-transitory computer-readable storage medium storing a computer program including a sequence of instructions to perform parallel processing of a deep learning model,
wherein the computer program includes a sequence of instructions that, when executed by a computing device, cause the computing device to:
load a deep learning model to a main process by a central processing unit (CPU);
partition parallelizable parameters included in the deep learning model by the CPU;
store the partitioned parallelizable parameters in a shared memory;
calculate partition parameters partitioned from the parallelizable parameters by a sub-process in each of a plurality of graphic processing units (GPUs) while access of the main process to the shared memory is stopped;
obtain a calculation result of the partition parameters from the shared memory by the CPU;
output the calculation result by the CPU.
